(19) United States
(12) Patent Application Publication
(10) Pub. No.: US 2010/0257868 A1
(43) Pub. Date: Oct. 14, 2010

(54) Method for generating power

(76) Inventor: David James Craze, Western Australia (AU)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 11/990,654

(22) PCT Filed: Aug. 18, 2006
(86) PCT No.: PCT/AU2006/000192

§ 371 Date: Feb. 19, 2008

(30) Foreign Application Priority Data
Aug. 19, 2005 (AU) 2005904497
Apr. 7, 2006 (AU) 2006901803

(51) Int. Cl. F02C 3/28

(52) U.S. Cl. 60/780; 60/39.12

(57) ABSTRACT

A method for power generation from carbonaceous feedstock comprising the steps of: gasifying the feedstock in a gasification unit to produce synthesis gas; passing a first portion of the synthesis gas to a power generation unit; passing a second portion of the synthesis gas to a chemical plant; condensing at least a portion of at least one gas stream produced; revaporising at least a portion of the at least one condensed gas stream; and wherein the step of revaporising at least a portion of the at least one condensed gas stream permits the power used in the step of condensing at least a portion of at least one gas stream to be recovered.

### FIELD OF THE INVENTION

The present invention relates to a method for generating power from carbonaceous feedstock.

### BACKGROUND ART

In operating large electrical power stations, it is desirable to generate power at close to full capacity and as steadily as possible for reasons of efficiency, reliability and stability of the overall electrical supply system. However, electrical system demands vary due to different consumer requirements on both a seasonal and daily basis. This requires either that a large plant be “turned down” at times of reduced power demand, a procedure which can be operationally troublesome and causes reduced generating efficiency, or conversely that smaller power generation facilities be installed that can be started and stopped quickly to accommodate peak power demand, which in turn can also be a costly and inefficient means of supplementary power generation.

The gasification of liquid and solid carbonaceous material such as coal, lignite, biomass, tar sand, petroleum coke, industrial waste and the like into synthesis gas (“syngas”) is a well established process. Generation of electrical power from such synthesis gas is typically accomplished by combustion with air in a gas turbine, the hot exhaust from which is passed through a heat exchanger to raise steam for additional power generation using a steam turbine, thus increasing overall power generation efficiency. Such an arrangement is usually termed a Combined Cycle Gas Turbine (CCGT) generation and the exchanger used to raise steam termed a Heat Recovery Steam Generator (HRSG). Moreover, the air compressor used in the gas turbine sometimes serves to supply compressed air to the Air Separation Unit (ASU) that produces the oxygen needed for gasification. When incorporated with a gasification-based front end that also generates high quality steam that can be directed to the aforesaid steam turbine, the whole is termed an Integrated Gasification Combined Cycle (IGCC).

The utilization of syngas to generate both electrical power via IGCC plus useful chemicals or liquid fuels (known as “co-generation”) is known. A common feature of such co-generation plants is that the process of synthesizing chemicals or fuels from syngas is highly exothermic. For example, U.S. Pat. No. 3,986,349 and PCT/US02/24839 which pertain to production of Fischer-Tropsch (FT) liquid fuels, U.S. Pat. No. 4,341,069 which pertains to production of dimethyl ether (DME) and U.S. Pat. No. 4,946,477 which pertains to production of methanol.

For example, U.S. Pat. No. 3,986,349 teaches a process for the generation of electrical energy from coal in which the coal is gasified to produce syngas, a portion of which is fed into a reaction zone containing hydrocarbon synthesis catalysts, (Fischer-Tropsch catalysts) to form a reaction product containing water, hydrogen, carbon monoxide, carbon dioxide, light hydrocarbons (such as methane, ethane, propane and butane) and normally liquid hydrocarbons having carbon numbers in the range C₅-C₂₂ or higher. The normally liquid hydrocarbons are separated and stored and combusted as required to generate additional power for peak load power demand. Further, the C₃ and C₄ hydrocarbons can be liquefied and stored under pressure and used as needed in the generation of additional power by combustion.

U.S. Pat. No. 4,341,069 teaches that hydrocarbonaceous material may be converted to syngas a portion of which burned and the hot gases expanded in one or more power generated turbines. A second portion of the syngas is converted into a storable fuel product comprising dimethyl ether which, during periods of low or normal power demand may be passed to onsite storage facilities. During periods of high power demand the stored fuel is then used to either supplement the syngas feed to the power generated turbines or charged separately to power generated turbines.

The above publications have the common feature that the synthesised liquids are stored for subsequent combustion or as feed to power generation turbines.

By incorporating appropriate heat recovery equipment in such chemical synthesis plants large quantities of useable steam can be generated, much of which may be used in large steam-driven compressor drivers, such as required for the ASU or syngas compressors upstream of the chemical or fuels synthesis plant. Steam so produced that is surplus to other plant heating requirements can be routed to the power generation turbine, often via the HRSG to increase its thermodynamic quality in a process known as “superheating”.

In the interest of attaining high overall thermal efficiency for the total complex, as well as to reduce capital cost by increasing the scale of common equipment such as the gasifier, the HRSG and the steam power turbine and its ancillaries, a high degree of process and plant integration is sought by the engineering designers. This is exemplified for example by the disclosures contained in PCT/US02/24839, U.S. Pat. No. 5,666,800 and U.S. Pat. No. 6,306,917. However, an outcome of such extensive integration is a significant increase in overall plant complexity that bodes for greater operating difficulties that, to be mitigated require extremely reliable equipment and carefully sequenced start-up, control and safety procedures that often need to be assisted by purpose-created computer algorithms. Moreover, the plant operating personnel need to be multi-skilled because the entire facility is neither a stand alone power plant nor a stand alone chemical plant, for which operating philosophies can substantially diverge.

The ability to co-generate power and chemicals or fuels leads to the concept of variable power generation, whereby syngas can be diverted between each product, in particular with change in external electrical power demand. Such “load-following” is usually proposed to be achieved by increasing liquid fuels production during off-peak periods for electricity demand, then combusting some of either intermediate or end product during times of peak power demand. Examples of such proposals are contained in the work of Griffiths of al. (“Swinging to Peak”, IChemE Third European Gasification Conference, September 1998), and in U.S. Pat. No. 5,543,437 and U.S. Pat. No. 6,306,917.

Diverse approaches to energy storage have also been disclosed previously, for example storage of compressed air in large underground caverns the formation and subsequent dissociation of storable organic molecules such as alkyl formate directly from carbon monoxide in the syngas as described in U.S. Pat. No. 4,524,581; and electrolysing water to produce hydrogen and oxygen that are stored for later recombination in fuel cells per U.S. Pat. No. 6,187,465.

Along with the extra expense of installing large compression and expansion equipment, the underground storage of large volumes of compressed air is problematical from the aspect of proximity to the power generator of a suitable subterranean reservoir that offers minimal leakage.

U.S. Pat. No. 4,524,581 teaches the capture, storage and release of carbon monoxide by forming and dissociating a suitable organic molecule such as methylformate, prepared by reaction of methanol with syngas. The methylformate is separated from the reactants and directed to a storage zone. During periods of high power demand, the methylformate may either provide fuel for power for variable demand or for other desired gas turbines by catalytically dissociating to carbon monoxide and methanol. The methanol may be used as either peak load fuel or stored for later process use, preferably as a feed for the formation of the methylformate. The method of the invention is said to satisfy peak load power requirements and provide an integrated highly efficient and environmentally clean operation for satisfying the greatly varying requirements of high, normal and low demand periods. Given the ready availability of methanol for use in peak-power gas turbines and the ready synthesis of methanol from the syngas, it is difficult to rationalise the need for an additional expense and complexity involved in introducing a dissociating chemical.

A gasification-based IGCC co-generation facility essentially produces its own gaseous fuel for the electrical power generator as well as the gaseous feedstock for the chemical or liquid fuels plant. However, the imposition of electrical load following onto such a facility wherein it is strongly preferred to operate the whole, or as much as practical of the whole, at maximum steady capacity, poses additional complexity in control plus demands on reliability over either conventional power and chemical plant.

As discussed above, to mitigate the consequent economic penalty some proponents of IGCC have advocated manufacture of chemicals from syngas that is excess to that needed for power generation, i.e. so-called “co-generation”. This approach allows front-end costs to be shared, but it does not readily overcome the difficulty of catering for a variable supply of syngas to the chemical plant, for which it is also preferable to ensure steady operation at high capacity. Such co-generation schemes also usually incorporate a similar approach as IGCC, that of a high degree of integration in an attempt to maximise efficiency and minimise capital costs, which could lead to even more operational complexities than IGCC by itself.

The preceding discussion of the background to the invention is intended to facilitate an understanding of the present invention. However, it should be appreciated that the discussion is not an acknowledgement or admission that any of the material referred to was part of the common general knowledge in Australia as at the priority date of the application.

Further, throughout the specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in the specification, individually or collectively and any and all combinations or any two or more of the steps or features.

The present invention is not to be limited in scope by the specific embodiments described herein, which are intended for the purpose of exemplification only. Functionally equivalent products, compositions and methods are clearly within the scope of the invention as described herein.

The entire disclosures of all publications (including patents, patent applications, journal articles, laboratory manuals, books, or other documents) cited herein are hereby incorporated by reference.

### DISCLOSURE OF THE INVENTION

In accordance with the present invention, there is provided a method for power generation from carbonaceous feedstock comprising the steps of:
gasifying the feedstock in a gasification unit to produce synthesis gas;
passing a first portion of the synthesis gas to a power generation unit;
passing a second portion of the synthesis gas to a chemical plant;
condensing at least a portion of at least one gas stream produced;
revaporising at least a portion of the at least one condensed gas stream; and
wherein the step of revaporising at least a portion of the at least one condensed gas stream permits the power used in the step of condensing at least a portion of at least one gas stream to be recovered.

In one form of the invention, the step of:
condensing at least a portion of at least one gas stream produced;
   comprises the step of:
condensing at least a portion of a gas stream utilized within the gasification unit.

In another form of the invention, the step of:
condensing at least a portion of at least one gas stream produced;
   comprises the step of:
condensing at least a portion of at least one gas stream produced in the chemical plant.

Advantageously, the method of the present invention can satisfy external peak load requirements with minimal interruption or turn-down of chemical production by allowing both diversion of syngas from the chemical plant to increase power from the electrical generating plant and reducing electrical power used by main consumers in the gasification unit and chemical plant that produce the condensable streams. For example, it may be possible to turn down or turn off the compressor or compressors used to condense the gas stream or gas streams, thereby making further power available.

A particular advantage of utilizing such a “swing-power” operating mode is that it allows the basic size of the power generation block to be better matched to projected electrical power demand, by reducing the need for installation of excess electrical generating capacity.

The carbonaceous feedstock may be selected from the group comprising coal, lignite, peat, petroleum coke, natural gas, oil shale, heavy mineral oil from an oil refinery, bitumen, petroleum coke, torrefied wood and biomass in general.

Preferably, the synthesis gas is a mixture of carbon monoxide and hydrogen.

In one form of the invention, the step of:
passing a first portion of the synthesis gas to a power generation unit;
   comprises the steps of:
combusting the synthesis gas; and
expanding the combustion gases in a gas turbine.

In one form of the invention, the expanded combustion gases are contacted with water in an HRSG or similar to produce steam and the steam is directed to a generator to produce power.

In one form of the invention, the step of:
gasifying the feedstock to produce synthesis gas;
   comprises the additional step of:
adding an oxygen-containing gas stream to the feedstock.

In one form of the invention, the step of:
gasifying the feedstock to produce synthesis gas;
   comprises the additional step of:
adding water to the feedstock.

It will be appreciated that a variety of gasification units are available, some of which are fed powdered coal as a water slurry (e.g. those provided by Conoco-Phillips and GE), others that require the coal to be fed as a dry powder (e.g. those provided by Shell and Siemens). The latter types may require additional water added as steam, usually in very small quantities. Most current gasification units have a slag water bath, wherein molten ash and slag is dumped to cool it, before disposal to an external ash heap.

It will be appreciated that the conditions in the gasification unit in terms of temperature and pressure will depend on the gasification unit employed. For a Shell dry feed gasifier, typical operating pressures and temperatures of respectively about 40 atm and 1500-1600° C. are typical. Other designs of gasifier can operate at even higher pressures.

The method may comprise the additional step of:
passing air through an air separation unit to produce an oxygen stream and a nitrogen stream.

In yet another form of the invention, the step of:
condensing at least a portion of the at least one gas stream produced;
   comprises the step of:
condensing at least a portion of a gas stream produced in the air separation unit.

The method may comprise the additional step of:
treating the synthesis gas
   prior to the steps of:
passing a first portion of the synthesis gas to a heat turbine; and
passing a second portion of the synthesis gas to a chemical plant.
   to remove entrained solids.

The step of:
treating the synthesis gas
   may further include the step of:
removing mercury with molecular sieves or activated carbon beds.

The step of:
treating the synthesis gas
   may further include the step of
removing sulfur containing gases and other acid gases such as H₂S, COS, CO₂.

In one form of the invention, the chemical plant is provided in the form of a ammonia/urea plant. Ammonia is generally prepared from nitrogen and hydrogen via the Haber Process. Urea is subsequently formed by reacting carbon dioxide and ammonia. Typical inlet conditions to an ammonia converter are 185 atm pressure, and 126° C., exit temperature following about 22.4 mol % conversion will be 414° C., at a pressure a few atm lower than inlet.

In an alternate form of the invention, the chemical plant is provided in the form of a methanol plant or a Fischer-Tropsch (FT) liquids plant. Methanol and FT liquids are generally formed by reaction of hydrogen and carbon monoxide in the presence of a catalyst under high pressure.

The step of condensing at least one gas stream produced may be performed by any method known in the art and it will be appreciated that the method used to condense a gas stream will be influenced by the properties of the gas stream.

Preferably, the step of:
condensing at least one gas stream produced,
   comprises the step of:
compressing the gas stream; and
removing the heat of compression and/or condensation by air or water cooling.

In one form of the invention, the step of:
condensing at least one gas stream produced,
   comprises the step of:
condensing at least a portion of the oxygen stream and/or the nitrogen stream from the air separation unit.

In another form of the invention, the step of:
condensing at least one gas stream produced,
   comprises the step of:
condensing at least a portion of the carbon dioxide stream recovered from the synthesis gas.

In yet another form of the invention, the step of:
condensing at least one gas stream produced,
   comprises the step of:
condensing at least a portion of the ammonia stream.

It will be appreciated that more than one gas stream may be condensed.

Preferably, the step of:
revaporising the at least one condensed gas stream
   comprises the step of:
heat exchange of the at least one condensed gas stream with steam, water or ambient air.

Advantageously, the step of:
heat exchange of the at least one condensed gas stream with steam, water or ambient air.
   maintains supply to the downstream unit.

The step of heat exchange of the at least one condensed gas stream with steam, water or ambient air is preferably performed in an evaporator that utilises low grade hot water from within the plant or ambient air or external water supply to vaporise the stored liquid.

Preferably, the method comprises the further step of:
unloading the compressor of said at lest one gas stream to permit the power normally consumed to be diverted to an external grid.

Preferably, the step of diverting synthesis gas from the chemical plant and routing said synthesis gas to the power generator comprises the step of:
routing stored intermediate fluids to final product synthesis.

The at least one condensed gas stream may be stored prior to the step of:
revaporising the at least one condensed gas stream.

It will be appreciated that the properties of the liquids will impact the storage options available. For example, ammonia and carbon dioxide may be stored in carbon steel vessels at high pressure and ambient temperature. Liquid ammonia may also be stored in insulated atmospheric-pressure storage tanks that are fabricated from carbon steel. Liquid oxygen and nitrogen are typically stored at atmospheric pressure but at cryogenic temperatures, usually in large pre-fabricated vacuum dewars or otherwise insulated storage tanks fabricated from stainless steel.

In one form of the invention, the method comprises the further step of:
utilising lower cost imported off-peak power to replenish or make additional stored liquids that are drawn upon during peak load times to maintain full chemical production.

In one form of the invention, the method comprises the further step of:
directing the accessed power to an external grid.

In accordance with the present invention, there is provided an apparatus for power generation from carbonaceous feedstock comprising a gasification unit having an inlet for carbonaceous feedstock, an outlet for synthesis gas, an air separation unit, a power generation unit, a chemical plant, means to condense at least one gas stream produced in the gasification unit, the air separation unit and/or the chemical plant, means to store the at least one gas stream and means to revaporise the at least one gas stream.

### BRIEF DESCRIPTION OF THE DRAWINGS

The present invention will now be described, by way of example only, with reference to one embodiment thereof, and the accompanying drawing, in which:—

FIG. 1 is a schematic flow sheet showing how a method in accordance with the present invention may be utilised in a combined ammonia/urea and power plant.

### BEST MODE(S) FOR CARRYING OUT THE INVENTION

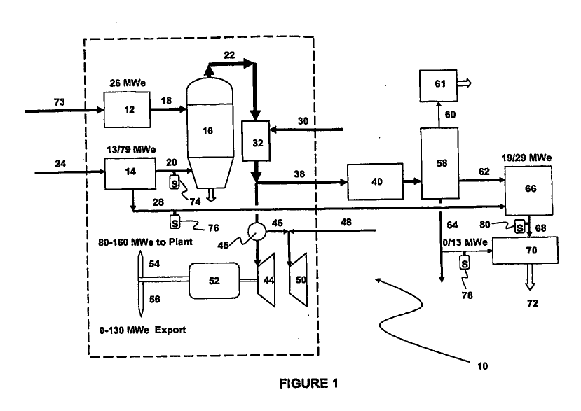

Without loss of generality, an example of the application of the present invention is the manufacture of ammonia-urea fertilizer in conjunction with power generated using synthesis gas composed mainly of hydrogen and carbon monoxide that is produced via coal gasification, such as illustrated in FIG. 1.

FIG. 1 shows a schematic flow sheet of a combined ammonia/urea and power plant 10. The “front-end” of the typical IGCC plant comprises coal milling and preparation facilities 12, an air separation unit 14 and a gasifier 16 within which the coal 18 is reacted with oxygen 20 to yield a hot syngas mixture 22. The air separation unit 14 separates air 24 into an oxygen stream 20 and a nitrogen stream 28.

For a Shell dry feed gasifier 16, typical operating pressures and temperatures of respectively about 40 atm and 1500-1600° C.

The syngas 22 is cooled by quenching with recycled cool syngas and/or water spray 30 in quench unit 32 prior to splitting respectively into a first stream 38 to the shift unit 40 of chemical plant and a second stream 42 to the gas turbine 44. Optionally, the hot syngas 46 may be further cooled in a heat exchanger 45 by raising steam 46 that is directed to a steam turbine 50. The gas turbine 44 and steam turbine 50 supply power to the electrical generating facility 52 that supplies power 54 both to the chemical plant and its combined front end, plus to external users as desired 56. Such facilities usually comprise the greatest proportion of capital equipment used in IGCC and therefore it is desirable that they be operated at as high a capacity factor as possible to maximize their economic return.

The first portion 38 of the syngas 22 is treated 58 to separate the hydrogen sulfide stream 60 that is further treated in a sulfur recovery unit 61, the hydrogen stream 62 and the carbon dioxide stream 64. The hydrogen stream 62 and the nitrogen stream 28 are combined in an ammonia synthesis unit 66 to form an ammonia stream 68. At least a portion of the carbon dioxide stream 54 and the ammonia stream 68 are combined in a urea production unit 70 to form urea 72.

The schematic in FIG. 1 depicts a raw lignite feedstock at 62.5% moisture content 73 (such as that sourced from the Latrobe Valley in Victoria, Australia) yielding 2500 TPD urea product, 72 whilst electrical power is simultaneously generated with a combined cycle gas turbine (CCGT) at a nominal 160 MWe, sufficient to supply the electrical needs of the entire complex that comprises ammonia/urea plant, coal drying and gasification front end and power plant.

In the present invention, the inverse of the industry approach to IGCC co-generation is applied. It is first assumed that electrical power demands for a syngas-fed chemical plant can be met via connection to a major electrical grid. The aforementioned front-end of the facility is then upsized to allow sufficient extra syngas to be produced to fuel a power plant of sufficient capacity to at least offset the steady state electrical demand of the chemical plant, plus optional additional power that can be economically exported to the external electrical grid. To ensure operational flexibility there is minimal integration between power plant and the remainder of the facility.

Advantageously, except for the extra syngas that is produced, the power block is essentially decoupled from the balance of the complex. A consequence of this decoupling is that prime movers for rotating machinery such as compressors and pumps within the chemical plant can be electrical motors in preference to steam turbines. This substitution facilitates easier start-up and operational control, as well as potentially lower overall capital expenditure. Moreover, because grid electrical power is derived from large steam or gas turbine generator units that are inherently more efficient than small ones, the overall power consumption of the chemical plant is reduced, resulting in a more efficient and energy-saving chemical plant.

It will be appreciated that excess steam may be available from the chemical plant and/or gasification unit itself, which could preferably be collected in a manifold (or manifolds) 48 and be directed independently to the steam turbine 50.

In conjunction with appropriate sizing of the power generation facility, by judicious selection of the main components of the facility and provision of appropriate volumes for the liquid storage “buffers”, it is possible to ensure fertilizer production at a consistently high capacity factor and at the same time allow flexible power generation, whilst maintaining operation of the coal milling and drying plus gasification facilities under optimum steady-state conditions. With reference to FIG. 1, the location of appropriate storage buffers is shown on the primary gas streams 20, 28, 64 and 68, along with some representative operating extremes for the key electrical power consumers within the complex that might be considered for interruptible or substantial turn-down.

Referring to FIG. 1, a typical operating scenario might comprise the following:
a) During periods when power demand external to the complex is low, excess power is used to build up the various liquid inventories 74, 76, 78, 80 whilst maintaining full plant production. This is achievable at low cost by ensuring that gasification facilities, main compressors and other associated liquefaction equipment have a modest capacity design margin. Typically this margin is set at about 10%, which engineering contractors and equipment suppliers usually incorporate in order that they can uphold performance guarantees. In periods of full plant production, there may actually be excess power economically available from an external power station or electrical supply grid, e.g. “off-peak” power that may be produced at night time that could be used in lieu, in so doing, reducing the total demand for syngas hence coal feedstock. In FIG. 1 the larger power numbers (26 MWe, 79 MWe, 29 MWe and 13 MWe that are depicted for the most significant electrical consumers represent this situation.
b) At times of peak power demand outside the plant, for perhaps 2-4 hours on a daily basis, major plant electrical consumers such as compressors, are turned down and stored liquids are revaporised to maintain chemical plant production. Surplus syngas is simultaneously diverted to the power plant to provide power that can be supplied to the external electrical grid. In FIG. 1 the smaller power numbers (13 MWe, 19 MWe, and 0 MWe, typify such a “turn-down” situation. For a CCGT based on a General Electric Frame 9E having a nameplate capacity of some 210 MWe, by diverting some syngas from the ammonia/urea plant, the amount of power that can be delivered to an external consumer will be in the order of 130 MWe, whilst the complex can continue to operate successfully through this peak demand period with only some 80 MWe instead of the usual 160 MWe.
c) At times of sustained peak power demand, it will be possible to partially turn down the ammonia/urea plant, or even shut the plant down entirely if the economic incentive exists, to sustain extra syngas to extend the duration of power export to the local electrical grid. Under such circumstances of shut-down of the ammonia/urea plant as much as 170 MWe can potentially be delivered using the same GE machine described above.

In contrast to normal IGCC power or co-generation plants wherein the gasification and power facilities are usually highly integrated, the present invention provides limited integration between power block and chemical plant, thereby the overall complex is capable of operating as a reliable flexible power generator. The gasification front end of the complex serves basically as a supplier of warm syngas to both the power block and the ammonia/urea plant. The power block is configured essentially as a ‘stand-alone’ base load generation facility, and in normal operation only supplies electrical power to the ammonia/urea plant. Therefore, other than the shared front end output, operation of the power block and ammonia/urea plant is de-coupled and each can operate independently from the other, assuming that electrical power is otherwise available for the chemical plant from a reliable external supply, such as an electrical grid.

It is preferable for implementation of the invention that the design of the power block is such as to allow the CCGT to operate normally at a high fraction of its nameplate capacity, typically in the range 60-80%, thereby keeping the gas turbine hot enough that it can respond quickly to increased supply of syngas that is diverted from the chemical plant, and to obviate excessive maintenance that may result from regular variation in total power demand.

It is further preferable for implementation of the invention to increase the liquid storage capacity beyond that normally required to overcome short term interruption though equipment malfunction. Depending on the frequency with which power swings need to be accommodated, and the excess production capacity of the ASU liquefaction equipment the liquid oxygen and nitrogen storage capacities may need to be substantially increased, perhaps to as much as 12 hours equivalent.

It will be appreciated that for implementation of the invention, the incorporation of reliable facilities for equipment turn down and subsequent ramp-up, particularly compressors and vaporisation facilities would be advantageous. The ability to turn down operating chemical plant in a controlled manner is usually part of normal engineering design, as is the ability to subsequently ramp up production. However, the rate of turndown and ramp-up, and the turndown extreme that is achievable may depend on the particular operating characteristics of process equipment, especially compressors. For compressors, there are several ways in which flow can be modulated whilst maintaining stable operating pressures in the process downstream:
Work within the turndown characteristics of the machine itself . . . typically limited to a range 50-110% of normal rated flow.
If a zero flow can be tolerated by the process, completely shut the compressor down.
Incorporate a recycle loop with supplementary cooling and control valves. A minimum net flow to the process below 10% of design can effectively be achieved, depending on characteristics of the control valve, but the compressor may need to remain operating at a large fraction of full power.
Replicate compressors to provide say 2×50% or 3×33% full design flow and through combination of all of the above methods, modulate the flow as needed.

Referring to the ammonia/urea plant as an example: for the syngas/ammonia recycle compressor that forms part of the ammonia synthesis unit, the first option above could likely be implemented; for the carbon dioxide compressors that are part of the urea synthesis unit the second option may be preferred; but for the ASU compressors, to achieve the operational flexibility for oxygen and nitrogen production whilst upholding overall ASU reliability, the last option is likely to be required.

In addition to designing for appropriate compressor operating mode(s), there may be a need to incorporate supplemental liquid vaporization facilities or controls. Revaporisation of stored liquids is typically achieved by heat exchange with steam, water or ambient air in appropriately designed evaporators. Assessment of the most appropriate heating medium and means of supply, evaporator surface area, etc, are typical engineering activities that are undertaken during the normal course of facility design, the objectives primarily being to attain the least cost for the required evaporator capacity using materials that are selected to last the required lifetime which may be 20-30 years.

Whilst the foregoing illustrates how the concept can apply to an ammonia-urea plant, a similar approach can apply in other chemical manufacturing plants, especially those producing synthetic transportation fuels (synfuels) including but not limited to methanol, DME and FT liquids, wherein very large ASUs in particular are usually required.

1. A method for power generation from carbonaceous feedstock comprising the steps of:
gasifying the feedstock in a gasification unit to produce synthesis gas;
passing a first portion of the synthesis gas to a power generation unit;
passing a second portion of the synthesis gas to a chemical plant for chemical production; and
condensing at least a portion of at least one gas stream produced;
wherein during periods of increased power generation, chemical production is maintained by revaporizing at least a portion of the at least one condensed gas stream and using said revaporized gas stream in chemical production.

2. The method for power generation according to claim 1, wherein the step of:
condensing at least a portion of at least one gas stream produced;
comprises the step of:
condensing at least a portion of the at least one gas stream utilized within the gasification unit.

3. The method for power generation according to claim 1, wherein the step of:
condensing at least a portion of the at least one gas stream produced;
comprises the step of:
condensing at least a portion of at least a gas stream produced in the chemical plant.

4. The method for power generation according to claim 1, wherein the carbonaceous feedstock is selected from the group comprising coal, lignite, peat, petroleum coke, natural gas, oil shale, heavy mineral oil from an oil refinery, bitumen, petroleum coke, torrefied wood and biomass in general.

5. The method for power generation according to claim 1, wherein the step of:
passing a first portion of the synthesis gas to a power generation unit;
comprises the steps of:
combusting the synthesis gas; and
expanding the combustion gases in a gas turbine.

6. The method for power generation according to claim 5, wherein the expanded combustion gases are contacted with water in a heat exchange apparatus to produce steam and the steam is directed to a generator to produce power.

7. The method for power generation according to claim 1, wherein the method comprises the additional step of:
passing air through an air separation unit to produce an oxygen stream and a nitrogen stream.

8. The method for power generation according to claim 1, wherein the method comprises the additional step of:
treating the synthesis gas to remove entrained solids.

9. The method for power generation according to claim 1, wherein the method comprises the additional step of:
treating the synthesis gas to remove mercury with molecular sieves or activated carbon beds.

10. The method for power generation according to claim 1, wherein the method comprises the additional step of:
treating the synthesis gas to remove gases containing sulfur H₂S, COS, or CO₂.

11. The method for power generation according to claim 1, wherein, the chemical plant is an ammonia/urea plant, a methanol plant or a Fischer-Tropsch liquids plant.

12. The method for power generation according to claim 1, wherein the step of:
condensing at least one gas stream produced,
comprises the step of:
compressing the gas stream; and
removing the heat of compression and/or condensation by air or water cooling.

13. The method for power generation according to claim 7, wherein the step of:
condensing at least a portion of the at least one gas stream produced,
comprises the step of:
condensing at least a portion of the oxygen stream or the nitrogen stream or both from the air separation unit.

14. The method for power generation according to claim 1, wherein the step of:
condensing at least one gas stream produced,
comprises the step of:
condensing at least a portion of a carbon dioxide stream recovered from the synthesis gas.

15. The method for power generation according to claim 1, wherein the step of:
condensing at least one gas stream produced,
comprises the step of:
condensing at least a portion of an ammonia stream.

16. The method for power generation according to claim 1, wherein the step of:
revaporizing at least a portion of the at least one condensed gas stream; and
wherein the step of revaporizing at least a portion of the at least one condensed gas stream permits the power used in the step of condensing at least a portion of at least one gas stream to be recovered.
comprises the step of:
heat exchange of the at least one condensed gas stream with steam, water or ambient air.

17. The method for power generation according to claim 16, wherein the step of:
heat exchange of the at least one condensed gas stream with steam, water or ambient air is performed in an evaporator that utilises low grade hot water from within the plant or ambient air or external water supply to vaporize the stored liquid.

18. The method for power generation according to claim 1, wherein the method comprises the further step of:
unloading the compressor of said at least one gas stream to permit the power normally consumed to be diverted to an external grid.

19. The method for power generation according to claim 18, wherein the step of diverting synthesis gas from the chemical plant and routing said synthesis gas to the power generator comprises the step of:
routing stored intermediate fluids to final product synthesis.

20. The method for power generation according to claim 1, wherein the at least one condensed gas stream is stored prior to the step of:
revaporizing the at least one condensed gas stream.

21. The method for power generation according to claim 1, wherein the method comprises the further step of:
directing the accessed power to an external grid.

22. An apparatus for power generation from carbonaceous feedstock comprising a gasification unit having an inlet for carbonaceous feedstock, an outlet for synthesis gas, an air separation unit, a power generation unit, a chemical plant, means to condense at least one gas stream produced in the gasification unit, the air separation unit and/or the chemical plant, means to store the at least one gas stream and means to revaporize the at least one gas stream.

23. (canceled)
